(19) United States
(12) Patent Application Publication
(10) Pub. No.: US 2003/0078836 A2
(43) Pub. Date: Apr. 24, 2003

(54) AVAILABILITY BASED ON VALUE CREATION METHOD AND SYSTEM

(75) Inventors: Mr. Richard M. Ratliff, Flower Mound, TX (US); Mr. Alan Walker, Southlake, TX (US); Mr. Barry C. Smith, Flower Mound, TX (US); Mr. Tony Joe Brice, N. Colleyville, TX (US)

Correspondence Address: Ernest F. Chapman, Douglas S. Weinstein, FINNEGAN, HENDERSON, FARABOW, GARRETT & DUNNER LLP, 1300 I Street, NW, Washington, DC, 20005

(73) Assignee: SABRE INC., Southlake, 76092-2129

(21) Appl. No.: 09/961,419

(22) Filed: Sep. 25, 2001

Related U.S. Application Data
(60) Provisional application No. 60/234,975, filed on Sep. 25, 2000.

(51) Int. Cl. G06F 17/60

(52) U.S. Cl. 705/14

(57) ABSTRACT

### Abstract of Disclosure

A method and system for providingprice information, comprising receiving a request for price information associated with at least one item; obtaining from a database results responsive to the request; modifying at least one entry in the database results to reflect a more competitive price, when compared to another entry in the database results; and providing the database results to a consumer after completing the modifying step.

### Cross Reference to Related Applications

Under provisions of 35 U.S.C. § 119(e), the Applicants claim the benefit of U.S. provisional application serial no. 60/234,975, filed September 25, 2000, which is hereby expressly incorporated herein by reference.

### Background of Invention

A. Field of the Invention

This invention relates to business methods and, more particularly, to an apparatus and methods for dynamically pricing products or services using one or more of the following: (i) information obtained in real-time; (ii) recently obtained information stored in cache; and (iii) information obtained through a batch process, based on multiple factors, which may include the current availability of the sought-after product or service, the current pricing of same or similar products or services offer by competitors, and/or the revenue goals of all suppliers.

B. Description of the Related Art

The Internet has been hailed the marketplace of the future, a result of its accessibility and usability. A computer equipped with a communication mechanism such as a modem and telephone connection is nearly all that is necessary to gain access to the Internet. A program called a browser, such as the Netscape Navigator from Netscape Corporation, makes it a simple task to traverse the vast network of information available on the Internet and, specifically, its subpart known as the "World Wide Web."

The architecture of the Web follows a conventional client-server model. The terms "client" and "server" are used to refer to a computer's general role as a requester of data (the client) or provider of data (the server). Under the Web environment, Web browsers reside in clients and specially formatted "Web documents" reside on Internet (Web) servers. Web clients and Web servers communicate using a conventional protocol called "HyperText Transfer Protocol" (HTTP).

In operation, a browser opens a connection to a server and initiates a request for a document. The server delivers the requested document, typically in the form coded in a standard such as the "HyperText Markup Language" (HTML) format. After the document is delivered, the connection is closed. The browser displays the document or performs a function designated by the document.

Every day, more people gain access to the Web, and every day, more of them are shopping online. Online shopping provides a level of convenience they want, need and will soon demand. Electronic commerce or "e-commerce" is the term often used to refer, at least in part, to online shopping on the Web. E-commerce is a unique opportunity for businesses of any size. E-commerce can expand a company's marketplace and consequently, its customer database. By simply providing a Web server having information on the company's product offerings and a customer database, and linking the Web server to the Web, the company can track visits, sales, buying trends and product preferences all at the customer level. The company can then present its customers with products they are most likely to buy on an individual basis. For this reason alone most marketing professionals consider the Web to be one of the best direct marketing tools.

But the number of retailers with online stores is growing exponentially every year, making it increasingly difficult for online shoppers to navigate the Web to locate particular products at the best prices. This challenge for consumers also introduces a problem for merchants in designing campaigns to attract consumers to the merchants' Web sites and away from their competitors' sites.

Many Web sites provide consumers with access to goods and services of multiple suppliers. Suppliers set the prices and when consumers seek price information on products and services, the set prices are provided. One problem with this approach is that it prevents competitors (suppliers) for the consumer's business from addressing a price differential between their competitive products or services immediately and before the Web site provides a response to the consumer with each supplier's price. It is entirely possible that the supplier with the higher set price may have available products that may satisfy the consumer's need and is willing to reduce the set price to a more competitive price, but the competitor is not able to do so in a real-time fashion using conventional technology.

Even though suppliers may be able to research their competitor's prices and then reprice their products, the subsequent repricing action by the supplier is accomplished after a manual review (by a sales or pricing analyst). Suppliers can use the proposed technology to dynamically reset their prices in an automated manner, considering both competitive prices and a set of repricing rules or parameters, in a real-time (or near real-time) basis. These parameters may include the current availability of the sought-after product or service, current pricing of the same or similar products or services offered by competitors, revenue goals of the suppliers, and/or the customer's buying history and/or product preferences.

There is therefore a need for a system that provides suppliers with the ability to compete more effectively in delivering products and services to consumers at competitive prices.

### Summary of Invention

Methods, systems, and articles of manufacture consistent with the present invention overcome the shortcomings of existing systems by dynamically pricing products or services using information obtained in real-time and/or recently obtained information stored in cache and/or information obtained through a batch process, based on multiple factors including current availability of the sought-after product or service, current pricing of the same or similar products or services offered by competitors, and/or revenue goals of all suppliers. In this application, a supplier may be any product or service provider comprising an airline, an intermediary entity that resells products or services, or any travel fulfillment entity.

An example of one embodiment of the present invention might be an airline whose current airfare, which is returned to the fare search engine for a given market pair (e.g., Washington to London), is either overpriced and/or unavailable; hence it is determined to be uncompetitive with other airlines for the same market pair. When a consumer seeks to book an itinerary for this market pair, conventional systems respond with information on all airlines with available seats on aircraft serving the market pair, including both the competitive and uncompetitive prices. The airline whose current published fare (or a special offering not normally available from the airline (an unpublished fare)) is provided to the fare search engine is uncompetitive, and therefore likely not to be chosen by a buyer, may process the opportunity via a method consistent with the present invention to determine whether a more competitive airfare can be offered. In other words, an uncompetitive supplier may have the inventory to fulfill a request but too high a price to compete effectively. Conversely, a supplier's fare availability may be much lower priced than any of its competitors for the same request, which creates an opportunity for an on-line fare increase (while still being competitive). Methods consistent with the present invention enable the uncompetitive supplier to consider and/or respond to this price differential before the potential buyer is provided with airfares for other suppliers in the example.

Using either pre-calculated (or estimated) bid prices for each potential leg of a journey, the new method determines whether to make seats available at a price deemed to be competitive. The price need not be less than others being offered but rather must provide competitive value to the buyer (a higher price might be considered competitive if it involved non-stop flights versus connecting flights, offered frequent flyer miles on the buyer's preferred airline, and the like). In economic terms, the bid price represents the airline's "indifference point," i.e., a higher price generates economic surplus while a lower price implies an opportunity cost exceeding the value of the sale being considered. The bid price is used to establish a minimum value below which dynamically created fares would not be set. For non-airline applications, the bid price would simply represent a minimum price below which the supplier refuses to sell (regardless of the competitive circumstances).

If this method determines that seats can be made available at a competitive price, the price is dynamically created and attached to the product or service being shopped (an air itinerary, a hotel rate, a vacation package, etc.). This evaluation and repricing process takes place before responding to the buyer with information on all suppliers with available products or services responsive to a request.

### Brief Description of Drawings

The accompanying drawings, which are incorporated in and constitute a part of this specification, illustrate an implementation of the invention and, together with the description, serve to explain the advantages and principles of the invention. In the drawings,

FIG. 1 is a pictorial diagram of a computer network in which systems consistent with the present invention may be implemented;

FIG. 2 shows a computer network containing a client system and a server system; and

FIG. 3 illustrates the retrieval of remote image and text and their integration in a document.

### Detailed Description

Reference will now be made in detail to an implementation consistent with the present invention as illustrated in the accompanying drawings. Wherever possible, the same reference numbers will be used throughout the drawings and the following description to refer to the same or like parts.

Introduction

Methods and systems consistent with the present invention enable dynamic pricing of goods or services, such as travel products using existing travel reservations system and Internet travel distribution channels. Such methods and systems build upon price search tools and processes already in use by the prevailing-existing travel reservation systems and Internet travel distribution channels in a unique way. At the core of this approach is the idea that, before final results of a search for product or service price information are presented to a consumer, the results of the search are reviewed with the intent of modifying the offerings. This is termed the "search and refine" approach because it offers the suppliers an opportunity to dynamically change their prices on the basis of their competitors' current and/or recently offered prices and availability. For example, suppliers set rules that are used to reprice products and services that are not deemed competitive before any price information is returned to the consumer. For the purposes of this description, a supplier may be any product or service provider comprising an airline, an intermediary entity that resells product or services, or any travel fulfillment entity.

Although the concepts of the embodiments of the invention are explained below in connection with travel products and services, they are obviously not limited to such products and services. The general approach should be extensible to almost anything that can be bought on-line (computer hardware and software, CD's, automobiles, insurance, mortgages, retail goods, etc.) using a search process involving competitive offerings, such as any electronic commerce method.

Today's processes work as follows. Reservation systems and Internet fare search engines use specialized techniques to review fare offerings, both published and unpublished (specially offered fares not normally available), across a number of different vendors (e.g. airlines, car rental companies, hotels, and the like) and return these results to the buyer in some ranked ordering (based on what attributes the customer has requested, e.g., lowest price ones first). So each travel vendor's systems lets the fare search engines know which of their fares are available for the dates and itinerary being considered, and the fare search engines sort through all the alternatives and select the best ones. The objective of traditional fare search processing is to find the best fare offers available in the marketplace.

One feature of systems and methods consistent with the present invention is that, before returning the results of the fare search process to the customer, they allow for automated processes acting on behalf of travel vendors to "preview" the results on a real-time basis and potentially change a fare pricing decision. For example, if Airline "A" has a fare offering that is overpriced (or underpriced) with that available on Airline "B", methods and systems consistent with the present invention allow Airline "A" to change its original decision and set a new price for that request. Business rules specified by each supplier determine whether their offerings are deemed competitive (or not).

It can be appreciated that business rules used to modify the fare may be executed on a rules processing engine that may be located on the supplier's computer system or, if the supplier is an intermediary, on the product or service provider's computer system. In the case where the rules processing engine resides on the product or service provider's computer system, the customer submits a request to the supplier. The supplier, in turn, submits the customer's request to the product or service provider, which processes the request based on the predetermined business rules and returns a response to the supplier, to be presented to the customer.

The new approach involves additional steps above and beyond what is performed in traditional fare search processing, in that it is a multi-step, iterative process of first getting the results and subsequently creating new fares (or modifying the availability of existing fare products). This approach is referred to as "search and refine" to denote the iterative nature.

Two separate methods for changing the fares that the travel vendor returned in the original search are: 1) repricing the existing fare products based on the supplier's business rules, and 2) dynamically changing the availability of existing fare products.

The most common conditions that can result in a fare not being able to be sold are known as fare restrictions. A common airline example would be the 14-day advance purchase fare of $500.00. Beginning 13 days before departure, a ticket can no longer be purchased at this fare even though there are still plenty of seats on the flight that you can purchase for $1,000.00. These advance purchase fare restrictions create a general incentive for customers to book their flights well prior to departure. Other common restrictions are Saturday night stay requirements, which encourage passengers to travel during the traditionally low demand weekend periods. Because of fare restrictions, discount fare sales will not generally be allowed in situations where the fare restrictions are violated (irrespective of expected demand). Even if the airline anticipates that a particular future flight departure will have many empty seats, a traveler will not be able to purchase the $500 discount fare when she is booking within 14 days of departure. This imbalance between the expected demand and the allowable fare sales during certain times and/or dates creates marketing opportunities to address the inefficiency. The second pricing method associated with the present invention (changing the availability of existing fare products) helps to address this type of imbalance by allowing airlines to improve their likelihood of winning sales when their existing fare products are uncompetitive. Airlines are able to waive or circumvent their restrictions and make their existing fare products available at the lower discount fare.

Another method that airlines use for managing discount sales is known as availability control (either traditional numeric availability or more modern bid-price control). The "bid price" is defined as the opportunity cost of having an unfilled seat at departure. "Bid prices" are one form of availability control that airlines use to limit sales for lower-valued fare types. For example, airlines often stop selling discounted seats for a particular flight long before the flight is full. In essence the airline is betting, based on everything it knows (e.g., forecasts for this particular origin and destination (O&D), forecast variability, leg/cabin availability, etc.), that it will be able to sell the seat for later-booking, higher-valued travelers. Bid prices increase as higher valued demand increases, and these increases reflect the scarcity of the available resource (i.e. seats on the flight and date that everyone else is trying to book). The opportunity cost (bid price) of selling a seat at a discounted price is near zero only if demand is low and that seat would otherwise certainly be empty at departure.

As the seats are sold in the days leading up to departure, however, the probability often increases that selling a discounted seat will require turning away a passenger at a higher fare. In the simplest terms, the opportunity cost of selling a discounted seat is defined as

p X c

where "p" is the probability the seat will be sold to a buyer at the higher fare before the flight departs, and "c" is the contribution that would be earned at that higher fare. If the probability was high (75%, for example) the opportunity cost would be .75 X $1,000 ($750.00).

Systems and methods consistent with the present invention identify the seat that will probably go unsold by departure if a discount is not offered at the moment potential buyers are attempting to view their options. This identification is done via bid prices provided by the airline systems; alternatively, bid prices can also be estimated from traditional numeric availability displays. For example, if forecasted demand is low and the probability of an unsold seat being bought at the available fare of $1,000 is only 2%, the bid price would be about $20 (.02 X $1,000). Selling these seats for $100.00 might be an attractive proposition for the supplier (vs. getting an expected value of $20.00 only). Alternatively, it might be advantageous for the supplier to get even $50.00 for the flight if the buyer would also use some frequent flyer miles. Furthermore, a computerized reservation service such as the one run by Sabre, Inc. or a travel agency might identify a buyer at $300.00; in such a case, the airline may be satisfied to get the $100.00 while Sabre and whoever it might need to share revenue with pockets the extra $200.00.

This could obviously apply to other travel and non-travel products as well; anywhere the possibility exists of excess capacity that could be sold via price actions.

Modified price information may be displayed in a manner to indicate to the consumer the modified pricing of certain suppliers. For example, the original search results may be reordered to include the new on-line offerings, and all this processing is done "behind the scenes" before the results are actually presented back to the customer. Alternatively, new fares may be displayed as "special offers" (probably showing up in the corner of the screen) to supplement the traditional display. Also, to help address concerns by the airlines that the new fares may dilute the value of inventory (i.e. take business away from their existing fares), the special offers may be displayed in a generic (i.e. unbranded) manner. For example, the carrier and flight number would not be revealed, flight times would be rounded to the nearest 15 minutes, and the product would be sold as an on-line special offer for instant purchase (without including the carrier's brand name). Also, by allowing a carrier to potentially recapture a sale that would otherwise have been lost to a competitor, the present invention is better characterized as share-shifting rather than dilutionary. In other words, the airline has recaptured a sale that would have been lost rather than diluting the value of its current inventory.

This general approach could be extended to most areas of the travel industry (including airlines, hotels, rental cars, tour packages, and charter services). It is also possible to extend the same "search and refine" to any pricing search process, whereby a competitive fare search is conducted, and fares are subsequently modified based on the results of that search.

Furthermore, consistent with the present invention, initial or revised fares could consist of both cash and non-cash elements (e.g. a mix of cash payment plus frequent traveler points or special redemption offers) to attract consumers. For example, a consumer may be offered a price for a product that reflects the consumer's status as a member of a frequent traveler program and may include money and/or frequent traveler points.

The following examples help to explain the principles of the present invention using a round-trip Baltimore (BWI) - San Diego (SAN) shopping scenario. In the following examples, two entries associated with a price, such as itinerary #1 - in Example 1, represent a two flight itinerary; whereas, four entries associated with prices, such as itinerary #4 - Example 1, represent a four flight itinerary. In the two flight itinerary, the first entry is the departure flight information and the second entry is the return flight information. In the four flight itinerary, the first and second entries are the departure-leg flight information and the third and fourth entries are the return-leg flight information. The entries in the flight itineraries of the following examples represent the following.

| | | | | | | | |
|---|---|---|---|---|---|---|---|
| UA | 467 | V | 21 SEP | BWI | SAN | 725A | 1133A |
| ↓ | ↓ | ↓ | ↓ | ↓ | ↓ | ↓ | ↓ |
| Airline Code | Flight Number | Booking Class | Departure Date | Departure City | Arrival City | Departure Time | Arrival Time |

Example 1

Below is a set of itineraries (search results) returned using the traditional methods of accessing and displaying buyer options:

Itinerary #1

UA 467 V 21SEP BWI SAN 725A 1133A

UA 1618 V 24SEP SAN BWI 825A 600P

$ 414.00

Itinerary #2

WN 97 H 21SEP BWI SAN 455P 830P

WN 96 H 24SEP SAN BWI 815A 515P

$ 414.00

Itinerary #3

HP 2193 W 21SEP BWI SAN 816A 1230P

HP 2241 W 24SEP SAN BWI 151P 1133P

$ 585.50

Itinerary #4

AA 1555 H 21SEP BWI ORD 700A 755A

AA 1447 H 21SEP ORD SAN 840A 1057A

AA 1256 H 24SEP SAN DFW 1130A 423P

AA 1110 H 24SEP DFW BWI 526P 926P

$ 1568.00

In this example, HP (American West) is obviously at a price disadvantage to United (UA) and Southwest (WN). All other things being equal, HP has a very small chance of getting this sale. American Airlines (AA), is at an even greater disadvantage since they are significantly higher in price and require a connection through Chicago (ORD) on the departure and a connection through Dallas-Fort Worth (DFW) on the return. All other things being equal, AA has virtually no chance of getting this sale.

In the proposed methods, these offerings would be filtered prior to providing them to the customer (e.g. displaying them on a monitor) on behalf of participating suppliers. The filtering process would then offer the same or similar itineraries at a lower price based on the applicable bid price for each leg and each suppliers' repricing rules logic, and display the offerings in a new order with revised pricing. Assuming HP and AA are participants, the display using the new method might appear as follows:

Itinerary #1

HP 2193 W 21SEP BWI SAN 816A 1230P

HP 2241 W 24SEP SAN BWI 151P 1133P

$ 358.00

Itinerary #2

AA 1555 V 21SEP BWI ORD 700A 755A

AA 1447 V 21SEP ORD SAN 840A 1057A

AA 1256 V 24SEP SAN DFW 1130A 423P

AA 1110 V 24SEP DFW BWI 526P 926P

$ 414.00

Itinerary #3

UA 467 V 21SEP BWI SAN 725A 1133A

UA 1618 V 24SEP SAN BWI 825A 600P

$ 414.00

Itinerary #4

WN 97 H 21SEP BWI SAN 455P 830P

WN 96 H 24SEP SAN BWI 815A 515P

$ 414.00

In the above example, HP's price has been reduced to $358.00 but the fare class W has not changed. This is an example of method 1 (i.e., repricing the existing fare based on the supplier's business rules). AA's price has also been reduced. Unlike HP, however, the AA price was reduced as the result of dynamically opening the availability of fare class V by 2 seats (fare class V was not available in the prior method example or the AA $ 414.00 option would have been displayed). Fare class V is a lower fare class than fare class H. This is an example of method 2 (i.e., dynamically changing the availability of existing fare products).

Example 2 (Scheduled-based price concession)

A filter for a supplier dynamically offers a lower fare based on the fact that the connecting flights and/or elapsed time increase the chance of a sale vs. more favorably scheduled options. For example, since American Airlines (AA) has an inferior schedule when compared to the other competitive offerings, it may provide a supplier rule that further reduces its price in these situations:

Itinerary #1

AA 1555 V 21SEP BWI ORD 700A 755A

AA 1447 V 21SEP ORD SAN 840A 1057A

AA 1256 V 24SEP SAN DFW 1130A 423P

AA 1110 V 24SEP DFW BWI 526P 926P

$ 304.00

Itinerary #2

HP 2193 W 21SEP BWI SAN 816A 1230P

HP 2241 W 24SEP SAN BWI 151P 1133P

$ 358.00

Itinerary #3

UA 467 V 21SEP BWI SAN 725A 1133A

UA 1618 V 24SEP SAN BWI 825A 600P

$ 414.00

Itinerary #4

WN 97 H 21SEP BWI SAN 455P 830P

WN 96 H 24SEP SAN BWI 815A 515P

$ 414.00

In this particular situation, AA realizes that its four flight itinerary (Itinerary #1) provides an inferior level of service than the two flight itinerary provided by HP, UA and WN. Therefore, AA has offered a lower fare than its competitors to increase its chances of securing the sale.

Example 3 (Non-cash awards)

A filter for a supplier detects that the shopper is an American Airlines AAdvantage frequent flyer and, based on a supplier rule, creates a slightly higher fare for the traveler that includes frequent flyer miles. The assumption here is that the buyer can be enticed to buy at a higher price with non-cash incentives offered at the point of sale. For example:

Itinerary #1

HP 2193 W 21SEP BWI SAN 816A 1230P

HP 2241 W 24SEP SAN BWI 151P 1133P

$ 358.00

Itinerary #2

UA 467 V 21SEP BWI SAN 725A 1133A

UA 1618 V 24SEP SAN BWI 825A 600P

$ 414.00

Itinerary #3

WN 97 H 21SEP BWI SAN 455P 830P

WN 96 H 24SEP SAN BWI 815A 515P

$ 414.00

Itinerary #4

AA 1555 V 21SEP BWI ORD 700A 755A

AA 1447 V 21SEP ORD SAN 840A 1057A

AA 1256 V 24SEP SAN DFW 1130A 423P

AA 1110 V 24SEP DFW BWI 526P 926P

$ 434.00 (includes 250 bonus AAdvantage Miles per traveler)

In this particular example, AA realizes that it is offering an inferior level of service (a four flight itinerary-itinerary #4), but believes that it can entice the customer to pay a slightly higher fare by including the 250 bonus AAdvantage miles per traveler.

Example 4 (Loyalty program consideration)

A filter for a supplier detects that the customer is an American Airlines AAdvantage frequent flyer and, based on a supplier rule, creates a lower fare provided the traveler also agrees to use a specified amount of frequent flyer miles/points. For example:

Itinerary #1

AA 1555 V 21SEP BWI ORD 700A 755A

AA 1447 V 21SEP ORD SAN 840A 1057A

AA 1256 V 24SEP SAN DFW 1130A 423P

AA 1110 V 24SEP DFW BWI 526P 926P

$ 150.00 + 5,000 AAdvantage Miles

Itinerary #2

HP 2193 W 21SEP BWI SAN 816A 1230P

HP 2241 W 24SEP SAN BWI 151P 1133P

$ 358.00

Itinerary #3

UA 467 V 21SEP BWI SAN 725A 1133A

UA 1618 V 24SEP SAN BWI 825A 600P

$ 414.00

Itinerary #4

WN 97 H 21SEP BWI SAN 455P 830P

WN 96 H 24SEP SAN BWI 815A 515P

$ 414.00

In this particular example, AA realizes that it is offering an inferior level of service (a four flight itinerary-itinerary #1), but believes that it can entice the customer to purchase the fare by offering a low fare, in comparison to its competitors, provided that the customer uses 5,000 AAdvantage miles. Although this example uses a frequent flyer membership to offer a lower price for airfare based on a combination that includes frequent flyer miles, this concept may also apply to other point-based programs (e.g., a hotel offering a lower room rate in conjunction with the use of a certain number of hotel membership points).

Example 5 (Automobile Sales price reduction needed)

Another example helps to explain the principles of the present invention when applied to non-airline applications, such as automobiles sales. In this exemplary scenario, two competing car dealerships (A and B) are returning on-line prices for the same car type (a luxury model). Depending on the current competitive availability, the present invention provides a dealer the opportunity to modify its prices to improve its revenue outcome. Note that, in this example, dealership "A" has a better location and recently won a major service award, so it feels that it can command a $250 price premium and still be competitive with dealership "B". Also, dealership "A"uses the proposed "search and refine" process invention to help ensure its on-line competitiveness. In this example, "A"has pre-negotiated a simple set of supplier rules regarding the fare refinement logic. First, if its competitive offer is more than $250 higher than the lowest priced dealership, it wants to limit its premium to only a $250 difference. Second, if its original price is found to be less than the lowest competitor, it wants to raise its price to equal the competitor. Third, for the luxury model vehicle, it never wants its revised price to fall below $30,000, regardless of the competitor"s price level (i.e. this rule is equivalent to the "bid price"in the airline example).

The following is the price initially returned by each dealership in response to an on-line price request:

| Dealership | Initial Price for Luxury model automobile |
|---|---|
| A | $31,650 |
| B | $31,000 |

Based on the rules logic, dealership "A"does not have a competitive offering. As such, before the above results are returned to the customer, dealership "A's" price is modified (on-line) to fall within the specified $250 premium limit (i.e. a $400 price reduction is made). The following is the final result actually presented to the customer:

| Dealership | Initial Price for Luxury model automobile |
|---|---|
| A | $31,250 |
| B | $31,000 |

By on-line reducing its price level to a more sensible premium ($250), dealership "A"has significantly improved its likelihood of winning the sale. Dealership "A" believes that its better location and recent award can command the $250 premium.

Example 6 (Automobile Sales price increase)

In this scenario, which uses the previous examples supplier rules regarding the fare refinement logic, dealership "A's"price is low compared to its competitor, and there is an opportunity to potentially improve "A's" revenue outcome by making an on-line price increase. The following is the original price returned by both dealerships:

| Dealership | Initial Price for Luxury model automobile |
|---|---|
| A | $30,500 |
| B | $31,200 |

As such, before the above results are returned to the customer, the price refinement rules logic indicates that dealership "As"price should be modified on-line to simply match its competitor (i.e. a $700 increase) in this situation. The following is the final result actually returned to the customer:

| Dealership | Initial Price for Luxury model automobile |
|---|---|
| A | $31,200 |
| B | $31,200 |

Given its location and service advantage, dealership "A" is still confident of its likelihood of winning the sale, despite the increase of its original price.

Example 7 (Supplier/Agent Arrangement - price marked up or offered at cost)

In another application of the invention, a supplier may employ similar methods to identify opportunities to mark up prices they have previously negotiated with an airline prior to displaying options to a customer. In this scenario, a supplier may be an appointed agent or other trading partner designated by the airline. The following example shows how a supplier might choose to dynamically price options prior to display:

Itinerary #1

AA 1555 V 21SEP BWI ORD 700A 755A

AA 1447 V 21SEP ORD SAN 840A 1057A

AA 1256 V 24SEP SAN DFW 1130A 423P

AA 1110 V 24SEP DFW BWI 526P 926P

Supplier's Negotiated Price:$ 300.00 s Negotiated Price:$ 300.00

Supplier's Displayed Price: $ 375.00

Published Price:$ 414.00

Supplier's price based on roundtrip net airfare of $300.00 negotiated by supplier/agent with AA.

Supplier makes $75.00 profit by dynamically marking price up 25% from $300.00 to $375.00.

Published price equals the supplier's displayed price plus any required taxes and surcharges.

Itinerary #2

HP 2193 V 21SEP BWI SAN 816A 1230P

HP 2241 V 24SEP SAN BWI 151P 1133P

Supplier's Negotiated Price:$ 320.00

Supplier's Displayed Price:$ 400.00

Published Price:$ 414.00

Supplier's price based on roundtrip net airfare of $320.00 negotiated by supplier/agent with HP.

Supplier makes $80.00 profit by dynamically marking price up 25% from $320.00 to $400.00.

Published price equals the supplier's displayed price plus any required taxes and surcharges charges.

Itinerary #3

UA 467 V 21SEP BWI SAN 725A 1133A

UA 1618 V 24SEP SAN BWI 825A 600P

Supplier's Displayed Price:$ 414.00

Published Price:$ 414.00

Based on roundtrip UA airfare of $414.00 commissionable at 5% to any supplier/agent.

Supplier makes $20.70 profit through 5% commission on published price of $414.00.

Published price equals the supplier's displayed price, which includes any required taxes and surcharges.

The first two options demonstrate itineraries for which the supplier has negotiated with AA and HP for prices lower than the generally available published price (the negotiated prices represent the amounts owed by the supplier to AA and HP on tickets sold for these itineraries). In the third option, the supplier has not negotiated a discount with UA; therefore, the supplier's displayed price is the same as the published price. During the filtering process, the methods of one embodiment of the present invention are used to identify itineraries for which discount prices have been negotiated, mark up those prices by a percentage (or amount) defined by the supplier, and reorder the results if desired.

The supplier might also choose to mark up the price of an itinerary so that it is simply either equal to or less than the lowest published price. In the above example, the supplier might have priced the AA and HP itineraries at $414.00 to equal the lowest available published price, $413.00 ($1 less than the lowest published price), or $393.30 (5% less than the lowest published price), depending on the competitive rules logic defined by the supplier.

Finally, the supplier might also choose not to mark up their negotiated discount price at all. For example, the supplier could offer air itineraries at cost for the purpose of enticing customers to its website in the hope that they would purchase other profitable products such as cruises, vacation packages, etc.

Although this example is described in the context of airfare pricing, it can be appreciated that the systems and methods of the present invention may be applied to other consumer products and services.

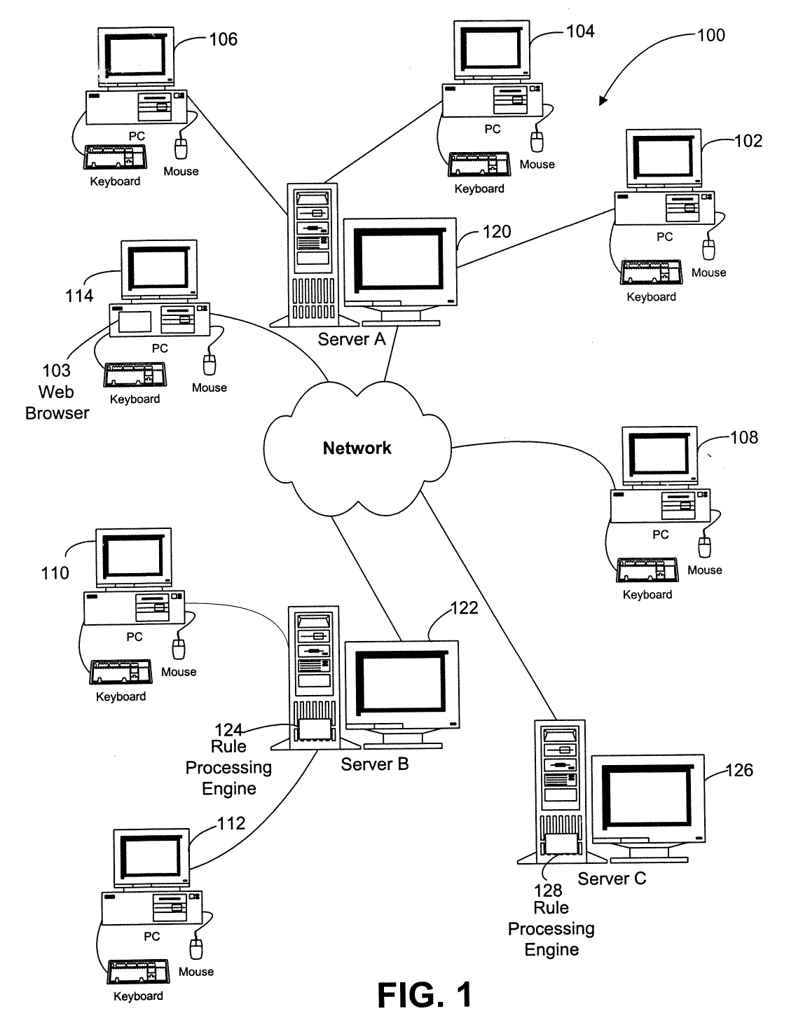

Systems and methods consistent with one embodiment of the present invention may be implemented using computer networks and computers similar to those described below in connection with Figures 1-3.

Network Architecture

Figure 1 illustrates a conceptual diagram of a computer network 100, such as the Internet. Computer network 100 comprises small computers (such as computers 102, 104, 106, 108, 110 and 112) and large computers (such as servers 120, 122 and 126). In general, small computers are "personal computers" or workstations and are the sites at which a human user operates the computer to make requests for data from other computers or servers on the network. Usually, the requested data resides in large computers. In this scenario, small computers are clients and the large computers are servers.

In this specification, the terms "client" and "server" are used to refer to a computer's general role as a requester of data (client) or provider of data (server). In general, the size of a computer or the resources associated with it do not preclude the computer's ability to act as a client or a server. Further, each computer may request data in one transaction and provide data in another transaction, thus changing the computer's role from client to server, or vice versa.

A client, such as computer 102, may request a file from server A 120. Since computer 102 is directly connected to server A 120, for example, through a local area network, this request would not normally result in a transfer of data over what is shown as the "network" of Figure 1. The "network" of Figurerepresents, for example, the Internet, which is an interconnection of networks. A different request from computer 102 may be for a file that resides in server B 122. In this case, the data is transferred from server B 122 through the network to server A 120 and, finally, to computer 102. The distance between server A 120 and server B 122 may be very long, e.g., across continents, or very short, e.g., within the same city. Further, in traversing the network, the data may be transferred through several intermediate servers and many routing devices, such as bridges and routers.

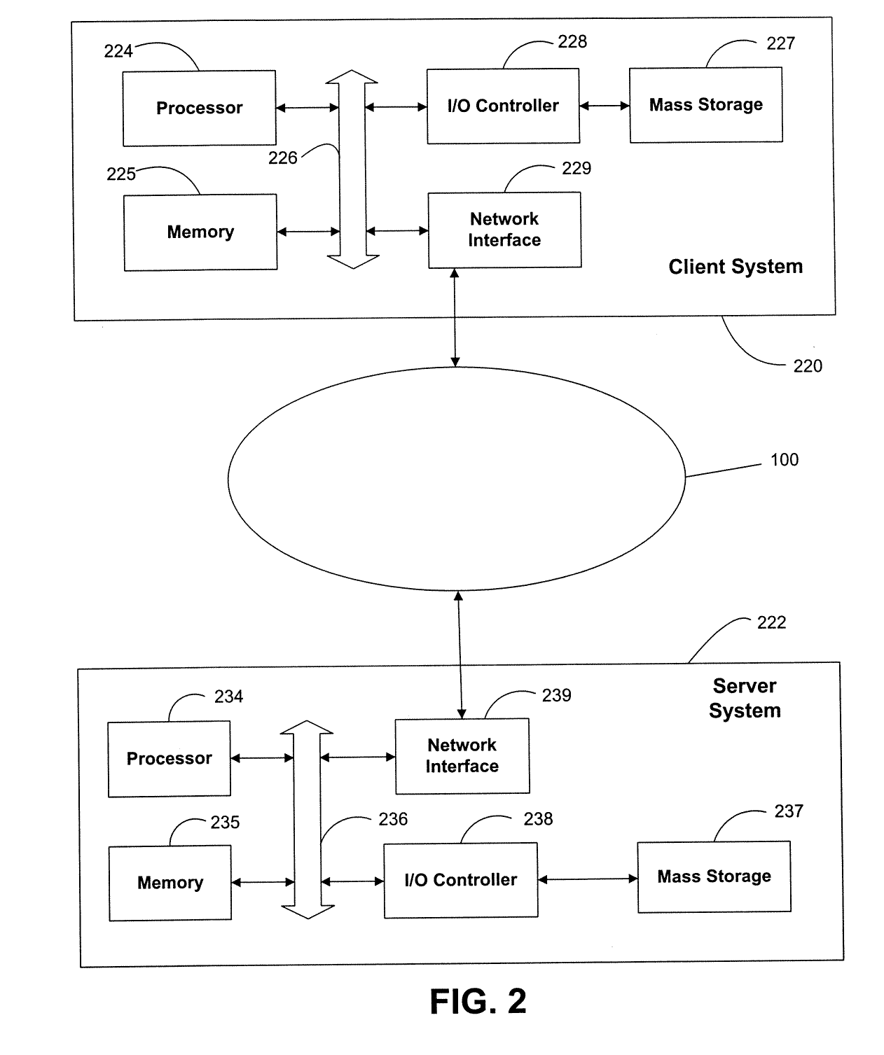

Figure 2 shows, in more detail, an example of a client-server system interconnected through network 100. In this example, a server system 222 is interconnected through network 100 to client system 220. Client system 220 includes conventional components such as a processor 224, memory 225 (e.g. RAM), a bus 226 which couples processor 224 and memory 225, a mass storage device 227 (e.g. a magnetic hard disk or an optical storage disk) coupled to processor 224 and memory 225 through an I/O controller 228, and a network interface 229, such as a conventional modem.

Server system 222 also includes conventional components such as a processor 234, memory 235 (e.g. RAM), a bus 236 which couples processor 234 and memory 235, a mass storage device 237 (e.g. a magnetic or optical disk) coupled to processor 234 and memory 235 through an I/O controller 238, and a network interface 239, such as a conventional modem. It will be appreciated from the description below that the present invention may be implemented in software which is stored as executable instructions on a computer readable medium on the client and server systems, such as mass storage devices 227 and 237 respectively, or in memories 225 and 235 respectively.

Distributed Document Retrieval

The Internet consists of a worldwide computer network that communicates using a well defined protocol known as the Internet Protocol (IP). Computer systems that are directly connected to the Internet each have an unique address consisting of four numbers separated by periods such as "192.101.0.3". To simplify Internet addressing, a "Domain Name System" was created that allows users to access Internet resources with a simpler alphanumeric naming system. For example, the name "travelocity.com" is the name for a computer operated by SABRE Inc.

To further define the addresses of resources on the Internet, a Uniform Resource Locator system was created that uses a Uniform Resource Locator (URL) as a descriptor that specifically defines a type of Internet resource and its location. URLs have the following format: "resource-type://domain.address/path-name." The "resource-type" defines the type of Internet resource. Web documents, for example, are identified by the resource type "http", which indicates the protocol used to access the document.

To access a document on the Web, the user enters a URL for the Web document into a browser program executed on a client, such as client system 220, with a connection to a network 100, such as the Internet. The Web browser then sends a request in accordance with the HTTP protocol to a Web server, such as server system 222, that has the Web document using the URL. The Web server responds to the request by transmitting the requested object to the client. In most cases, the object is a plain text document containing text (in ASCII) that is written in HTML. Such objects often contain hyperlinks to other Web documents. The Web browser displays the HTML document on the screen for the user and the hyperlinks to other Web documents are emphasized in some fashion such that the user can selected the hyperlink.

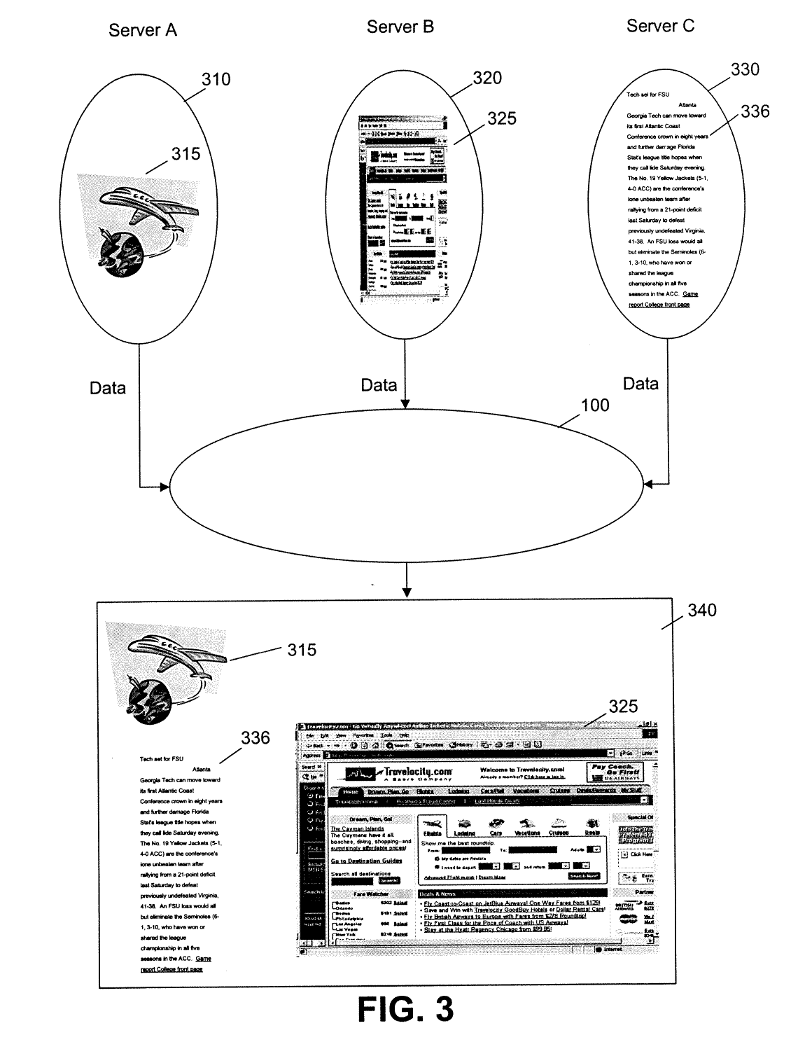

In some instances, the HTML document may contain data from more than one server. For example, Figure 3 illustrates the retrieval of remote text and images, and their integration in a Web document by a client system 340. In Figure 3, server A 310 contains an image 315, server B 320 contains a combination of text and image data 325 and server C 330 contains text data 336. Each of these servers is remotely located from the other servers and client 340. The transfer of data is via network 100. It should be appreciated that the text 336 and image 315 could be located in the same server which is remote from client 340.

Different techniques are available to display these types of composite Web documents. For example, a program called a servlet executing on one of the servers may combine data from the various servers referenced in a selected Web document and transmit the composite Web document to the client. In other configurations, the client may utilize a program called an applet, which may be transmitted to the client from one of the servers, to access the multiple servers offering parts of the composite and to build the composite Web document.

Exemplary Embodiment

An exemplary embodiment of the present invention will be described utilizing the network architecture of Figures 1 and 2. In the exemplary embodiment of the present invention, a customer using client 114 and web browser 103 may type in the Uniform Resource Locator (URL) for a travel supplier"s web server, which may be server B 122 of Figure 1.

The web browser then sends a request in accordance with the HTTP protocol to web server B 122 to retrieve the travel-related web document using the URL. Web server B 122 responds by transmitting the web document to client 114. Once the customer receives the web document on the web browser 103, the customer may enter the travel request (e.g., the dates of travel and the approximate arrival and departure times) into the web document.

The web browser then submits the travel request to web server B 122, web server B 122 may process the request by: (1) using recently acquired travel information stored in cache or information acquired through a batch process and rule processing engine 124; (2)a request to a server, such as Server C 126, operated by a product or service provider for processing on rule processing engine 128; and/or (3)price information from a server, such as Server C 126, operated by a product or service provider, and processing the received information on rule processing engine 124 (server B 122).

After rule processing engine (124 and 128) process the request by applying the supplier's business rules to its current fares, a response is returned through server B 122 to web browser 103. Web browser 103 presents the customer with the response which includes the most competitive price the supplier is willing to offer for the particular travel request.

It is important to note that this exemplary embodiment is not limited to the request being processed for or by only one supplier. The request may be processed in web server B 122 for a number of product or service providers and/or the request may be submitted to a number of servers, such as server C 126, for processing on the individual product or service provider's computer system.

Conclusion

As explained, systems consistent with the present invention permit suppliers to dynamically modify price offerings to compete better in markets for goods and services.

The foregoing description of an implementation of the invention has been presented for purposes of illustration and description. It is not exhaustive and does not limit the invention to the precise form disclosed. Modifications and variations are possible in light of the above teachings or may be acquired from practicing of the invention. For example, the described implementation includes software but the present invention may be implemented as a combination of hardware and software or in hardware alone. The invention may be implemented with both object-oriented and non-object-oriented programming systems. Additionally, although aspects of the present invention are described as being stored in memory, one skilled in the art will appreciate that these aspects can also be stored on other types of computer-readable media, such as secondary storage devices, like hard disks, floppy disks, or CD-ROM; a carrier wave from the Internet or other propagation medium; or other forms of RAM or ROM. The scope of the invention is defined by the claims and their equivalents.

CLAIMS

1. A method for providing price information, comprising the steps of:receiving a request for price information associated with at least one item;obtaining database results from a database responsive to the request;modifying at least one entry in the database results to reflect a more competitive price when compared to another entry in the database results; andproviding the database results to a consumer after completing the modifying step.

2. The method of claim 1, wherein the at least one entry is modified in real time.

3. The method of claim 1, wherein the at least one entry is modified based on recently obtained information stored in cache.

4. The method of claim 1, wherein the at least one entry is modified based on information obtained through a batch process.

5. The method of claim 1, wherein the database results are modified by combining a price and a non-monetary incentive to produce the more competitive price.

6. The method of claim 1, wherein the database results are modified using at least one of increasing the price, decreasing the price, and modifying the price, based on a level of service provided, to produce the more competitive price.

7. The method of claim 1, wherein the database results are modified by changing the availability of a class fare to produce the more competitive price.

8. The method of claim 1, wherein the database results are modified by marking up the at least one entry, while maintaining a competitive price.

9. The method of claim 1, wherein the database results are modified by submitting in real time a second request to a second database and receiving information to produce the more competitive price.

10. The method of claim 9, wherein the received information from the second database is based on information received with the second request.

11. A method for receiving price information, comprising:providing a request for price information associated with an item;
receiving database results responsive to the request, including at least one entry that has been modified with information from a database to reflect a more competitive price when compared to another entry in the database results.

12. The method of claim 11, wherein the at least one entry is modified in real time.

13. The method of claim 11, wherein the at least one entry is modified based on recently obtained and stored information.

14. The method of claim 11, wherein the at least one entry is modified based on information obtained through a batch process.

15. The method of claim 11, wherein the at least one entry is modified by combining a price and a non-monetary incentive to produce the more competitive price.

16. The method of claim 11, wherein the at least one entry is modified by using at least one of increasing the price, decreasing the price, and modifying the price, based on a level of service provided, to produce the more competitive price.

17. The method of claim 11, wherein the at least one entry is modified by changing the availability of a class fare to produce the more competitive price.

18. The method of claim 11, wherein the at least one entry is modified by marking up the at least one entry, while maintaining a competitive price.

19. The method of claim 11, wherein the at least one entry is modified by submitting in real time a second request to a second database and receiving information to produce the more competitive price.

20. The method of claim 19, wherein the received information from the second database is based on information received with the second request.

21. A method for providing information, comprising:
receiving a request for information associated with an item;
obtaining database results from a database responsive to the request;
modifying at least one entry in the database results to reflect a more competitive position when compared to another entry in the database results; and
providing the database results to a consumer after completing the modifying step.

22. The method of claim 21, wherein the at least one entry is modified in real time.

23. The method of claim 21, wherein the at least one entry is modified based on recently obtained and stored information.

24. The method of claim 21, wherein the at least one entry is modified based on information obtained through a batch process.

25. The method of claim 21, wherein the at least one entry is modified by combining a price and a non-monetary incentive to produce the more competitive position.

26. The method of claim 21, wherein the at least one entry is modified by using at least one of increasing a price, decreasing the price, and modifying the price, based on a level of service provided, to produce the more competitive position.

27. The method of claim 21, wherein the at least one entry is modified by changing the availability of a class fare to produce the more competitive position.

28. The method of claim 21, wherein the at least one entry is modified by marking up the at least one entry, while maintaining a competitive position.

29. The method of claim 21, wherein the at least one entry is modified by submitting in real time a second request to a second database and receiving information to produce the more competitive position.

30. The method of claim 29, wherein the received information from the second database is based on information received with the second request.

31. A method for providing information, comprising:
receiving from a requestor a request specifying at least one item from a set of products and services of interest;
determining a price for the specified at least one item associated with at least one supplier from a set of suppliers capable of providing the specified at least one item;
modifying the price for the at least one item associated with the at least one supplier from the set of suppliers to reflect a more competitive position when compared to the price associated with at least one other supplier in the set of suppliers; and
providing price information to the requestor, including the modified price.

32. The method of claim 31, wherein the price for the at least one item is modified in real time.

33. The method of claim 31, wherein the price for the at least one item is modified based on recently obtained and stored information.

34. The method of claim 31, wherein the price for the at least one item is modified based on information obtained through a batch process.

35. The method of claim 31, wherein the price to reflect the more competitive position is modified by combining the price with a non-monetary incentive to produce the more competitive position.

36. The method of claim 31, wherein the price of at least one item is modified by using at least one of increasing a price, decreasing the price, and modifying the price, based on a level of service provided, to produce the more competitive position.

37. The method of claim 31, wherein the price of the at least one item is modified by changing the availability of a class fare to produce the more competitive position.

38. The method of claim 31, wherein the price of the at least one item is modified by marking up the price, while maintaining a competitive position.

39. The method of claim 31, wherein the price of the at least one item is modified by submitting in real time a second request to a database and receiving information to produce the more competitive position.

40. The method of claim 39, wherein the received information from the database is based on information received with the second request.

41. A network node that provides information, comprising:
a receiving device for receiving a request for information associated with an item;
a database, accessible by the device, that provides results responsive to the request;
a rule processor that modifies at least one entry in the results to reflect a more competitive position when compared to another entry in the results; and
a display device that displays the results to a consumer after the rule processor modifies the at least one entry.

42. The network node of claim 41, wherein the rule processor modifies the at least one entry in real time.

43. The network node of claim 41, wherein the rule processor modifies the at least one entry based on recently obtained and stored information.

44. The network node of claim 41, wherein the rule processor modifies the at least one entry based on information obtained through a batch process.

45. The network node of claim 41, wherein the rule processor modifies the at least one entry by combining a price and a non-monetary incentive to produce the more competitive position.

46. The network node of claim 41, wherein the rule processor modifies the at least one entry by using at least one of increasing a price, decreasing the price, and modifying the price, based on a level of service provided, to produce the more competitive position.

47. The network node of claim 41, wherein the rule processor modifies the at least one entry by changing the availability of a class fare to produce the more competitive position.

48. The network node of claim 41, wherein the rule processor is located in a second network node and modifying the at least one entry comprises submitting in real time the request to the rule processor and receiving information with the more competitive position.

49. A network node system that provides information, comprising:
means for receiving a request for information associated with an item;
means for obtaining from a database results responsive to the request;
means for modifying at least one entry in the results to reflect a more competitive position when compared to another entry in the results; and
means for providing the results to a consumer after completing the modification of the at least one entry.

50. The system of claim 49, wherein the means for modifying the at least one entry modifies the at least one entry in real time.

51. The system of claim 49, wherein the means for modifying the at least one entry modifies the at least one entry based on recently obtained and stored information.

52. The system of claim 49, wherein the means for modifying the at least one entry modifies the at least one entry based on information obtained through a batch process.

53. The system of claim 49, wherein the means for modifying the at least one entry modifies the at least one entry by combining a price and a non-monetary incentive to produce the more competitive position.

54. The system of claim 49, wherein the means for modifying the at least one entry modifies the at least one entry by using at least one of increasing a price, decreasing the price, and modifying the price, based on a level of service provided, to produce the more competitive position.

55. The system of claim 49, wherein the means for modifying the at least one entry modifies the at least one entry by changing the availability of a class fare to produce the more competitive position.

56. The system of claim 49, wherein the means for modifying the at least one entry modifies the at least one entry by marking up the at least one entry, while maintaining a competitive position.

57. The system of claim 49, wherein the means for modifying the at least one entry modifies the at least one entry by submitting in real time a second request to a second database and receiving information to produce the more competitive position.

58. The system of claim 57, wherein the received information from the second database is based on information received with the second request.

59. A method for providing information, comprising:
receiving a request for information associated with an item;
obtaining results from at least one server responsive to the request;
modifying at least one entry in the results to reflect a more competitive position when compared to other entries in the results; and
providing the results to a consumer after the at least one entry is modified.

60. The method of claim 59, wherein modifying the at least one entry includes providing the at least one entry at cost to reflect the more competitive position.

61. The method of claim 59, wherein modifying the at least one entry further comprises sharing revenue derived from a sale of the at least one entry between an agent and a supplier of the item.

62. The method of claim 59, wherein modifying the at least one entry includes providing the more competitive position for the at least one entry in exchange for a non-monetary incentive.

63. The method of claim 59, wherein modifying the at least one entry includes applying a set of supplier rules to the at least one entry to determine a price associated with the at least one entry.

64. The method of claim 63, wherein applying the set of supplier rules includes increasing the price associated with the at least one entry to match at least one of the other entries in the results.

65. The method of claim 63, wherein applying the set of supplier rules includes providing the more competitive position, while maintaining a minimum price for the at least one entry.

66. The method of claim 63, wherein applying the set of supplier rules includes providing the more competitive position, while maintaining a premium value above at least one of the other entries in the results.

67. The method of claim 59, wherein modifying the at least one entry includes using one of real time, recently stored, and batched information.

68. The method of claim 59, wherein modifying the at least one entry includes combining a price and a non-monetary incentive to produce the more competitive position.

69. The method of claim 59, wherein modifying the at least one entry includes increasing the price, decreasing the price, and modifying the price, based on a level of service provided.

70. The method of claim 59, wherein modifying the at least one entry includes changing the availability of a class fare to produce the more competitive position.

71. The method of claim 59, wherein modifying the at least one entry includes marking up the at least one entry above a supplier provided price and sharing the revenue derived from the at least one entry between the supplier and an agent, which provided the at least one entry to the consumer.

72. The method of claim 71, wherein marking up the at least one entry includes negotiating a price between the supplier and agent and marking up the price by using one of a percentage or an amount for the agent to derive revenue from the at least one entry.

73. The method of claim 71, wherein marking up the at least one entry above the supplier provided price includes marking up the supplier provided price to be one of equal and less than other entries in the results.

74. A network node that provides information, comprising:
means for receiving a request for information associated with an item;
means for providing results responsive to the request;
means for modifying at least one entry in the results to reflect a more competitive position when compared to other entries in the results; and
means for displaying the results to a consumer after the at least one entry is modified.

75. The network node of claim 74, wherein the means for modifying the at least one entry modifies the at least one entry by providing the at least one entry at cost to reflect the more competitive position.

76. The network node of claim 74, wherein the means for modifying the at least one entry shares revenue between an agent and a supplier of the item.

77. The network node of claim 74, wherein the means for modifying the at least one entry provides the more competitive position in exchange for a non-monetary incentive.

78. The network node of claim 74, wherein the means for modifying the at least one entry applies a set of supplier rules to the at least one entry to determine a price associated with the at least one entry.ef

79. The network node of claim 78, wherein the set of supplier rules applied include rules for increasing the price associated with the at least one entry to match at least one of the other entries in the results.

80. The network node of claim 78, wherein the set of supplier rules include rules for providing the more competitive position, while maintaining a minimum price for the at least one entry.

81. The network node of claim 78, wherein the set of supplier rules include rules for providing the more competitive position, while maintaining a premium value above at least one of the other entries in the results.

82. The network node of claim 74, wherein the means for modifying the at least one entry modifies the at least one entry by using one of real time, recently stored, and batched information.

83. The network node of claim 74, wherein the means for modifying the at least one entry modifies the at least one entry by combining a price and a non-monetary incentive to produce the more competitive position.

84. The network node of claim 74, wherein the means for modifying the at least one entry modifies the at least one entry by using one of increasing the price, decreasing the price, and modifying the price, based on a level of service provided.

85. The network node of claim 74, wherein the means for modifying the at least one entry modifies the at least one entry by changing the availability of a class fare to produce the more competitive position.

86. The network node of claim 74, wherein the means for modifying the at least one entry marks up the at least one entry above a supplier provided price and shares the revenue derived from the at least one entry between the supplier and an agent, which provided the at least one entry to the consumer.

87. The network node of claim 86, wherein the means for modifying the at least one entry marks up the at least one entry by negotiating a price between the supplier and agent and marks up the price by using one of a percentage and an amount for the agent to derive revenue from the at least one entry.

88. The network node of claim 86, wherein the means for modifying the at least one entry marks up the at least one entry by increasing the supplier provided price to be one of equal and less than other entries in the results.
